(19) United States
(12) Patent Application Publication
(10) Pub. No.: US 2019/0070690 A1
(43) Pub. Date: Mar. 7, 2019

(54) SEAM WELDING METHOD AND SEAM WELDING DEVICE

(71) Applicant: HONDA MOTOR CO., LTD., MINATO-KU, TOKYO (JP)

(72) Inventors: Mitsutaka IGAUE, TOCHIGI (JP); Yuya ISHIKAWA, TOCHIGI (JP); Yasuhiro KAWAI, TOCHIGI (JP); Tetsuya KODAMA, TOCHIGI (JP); Kazuhiko YAMAASHI, TOCHIGI (JP)

(21) Appl. No.: 16/084,716

(22) PCT Filed: Mar. 9, 2017
(86) PCT No.: PCT/JP2017/009584

§ 371 Date: Sep. 13, 2018

(30) Foreign Application Priority Data
Mar. 14, 2016 (JP) 2016-049649

(51) Int. Cl. B23K 11/06; B23K 11/11; B23K 11/25; B23K 11/31

(52) U.S. Cl. CPC B23K 11/062; B23K 11/115; B23K 2101/006; B23K 11/318; B23K 11/253

(57) ABSTRACT

A laminate formed by stacking a plurality of workpieces is sandwiched between a pair of roller electrodes. Then, seam welding is performed on the laminate by successively repeating an ON/OFF operation of a conduction state between the pair of roller electrodes while moving the laminate relative to the pair of roller electrodes. When the seam welding stops in a state where the pair of roller electrodes are unpowered and then the seam welding is to be resumed, the laminate is moved by a predetermined distance in a direction opposite to the relative moving direction during seam welding, spot welding is performed on the laminate, and then the seam welding is resumed.

### TECHNICAL FIELD

The present invention relates to a seam welding method and a seam welding device for performing seam welding on a laminate by supplying power between a pair of roller electrodes while moving the laminate sandwiched between the pair of roller electrodes relative to the pair of roller electrodes.

### BACKGROUND ART

Seam welding is widely known as a method of joining metal plates with each other in a linear and continuous manner. Examples of the method include a method in which a pair of roller electrodes are used to press and sandwich the stacked metal plates (laminate) and then perform welding on the laminate by successively repeating an ON/OFF operation of a conduction state between the pair of roller electrodes while relatively moving the laminate and the pair of roller electrodes (for example, see Patent Literature 1). Such a seam welding is automatically performed by the seam welding device and thus is useful because joining operation can be performed for a shorter time and with higher accuracy than manual operation.

### CITATION LIST

### Patent Literature

Patent Literature 1: Japanese Patent Laid-Open No. 2013-166178

### SUMMARY OF INVENTION

### Technical Problem

When a normal seam welding process stops due to a power outage, a facility failure, or the like, welding current is cut off immediately, but the movement of a pair of roller electrodes relative to the laminate cannot stop immediately. Thus, the pair of roller electrodes move by a predetermined distance and then stop. Even if the seam welding is resumed from the stopped position, the seam welding is not performed in the distance from the position where the welding current is cut off to the position where the movement of the pair of roller electrodes stops relative to the laminate, thus leaving unwelded portions. In order to solve this problem, a wrapping process is performed so as to wrap a terminal end of a bead and a starting end of the bead, to thereby maintain continuity from a starting end portion to a terminal end portion.

However, in the case of recent seam welding of steel sheets for automobiles, most of the steel sheets are made of high tensile strength steel having different plate thicknesses. Thus, when such a wrapping process is performed, welding defects such as spatter and porosity occur. In order to avoid this problem, when the seam welding is stopped and then resumed, the seam welding process is suspended with the terminal and starting end portions remaining unwelded, and then spot welding is performed for reinforcement as a separate process as needed, resulting in an increase in manufacturing cost and variations in manufacturing time and the like.

In view of the above conventional problems, the present invention has been made so as to provide a seam welding method and a seam welding device which enable seam welding free from unwelded portions without the need to perform spot welding as a separate process after the end of seam welding even if the seam welding undergoes an emergency stop due to a facility failure such as a power outage.

### Solution to Problem

A seam welding method of the present invention is a seam welding method for performing seam welding on a laminate, the laminate being formed by stacking a plurality of workpieces, by sandwiching the laminate between a pair of roller electrodes and supplying power between the pair of roller electrodes while moving the pair of roller electrodes relative to the laminate, wherein

when the seam welding stops in a state where the pair of roller electrodes are unpowered and then the seam welding is to be resumed, the pair of roller electrodes are moved by a predetermined distance in a direction opposite to a relative moving direction during seam welding, spot welding is performed on the laminate, and the seam welding is resumed after the spot welding is performed.

In the seam welding method of the present invention, in a case where a facility failure such as a power outage occurs during execution of seam welding, the seam welding undergoes an emergency stop in a state where the pair of roller electrodes are unpowered, and then the facility recovers from the failure, the pair of roller electrodes are moved by a predetermined distance in a direction opposite to a direction of running the pair of roller electrodes relative to the laminated plate during the seam welding, at which position spot welding is performed and then the seam welding is resumed. Therefore, even if the seam welding undergoes an emergency stop, thus leaving unwelded portions, the pair of roller electrodes are returned by a predetermined distance, at which position spot welding is performed on the unwelded portions, thereby maintaining continuity of the bead. This eliminates the need to provide a separate spot welding process after the end of the seam welding.

In the seam welding method of the present invention, the position at which spot welding is performed on the laminate is preferably a position away from a terminal end portion of a nugget by seam welding formed in the laminate immediately before the emergency stop. The shunt current of the spot welding can be suppressed by performing spot welding at a position away from the nugget by the seam welding, thus facilitating formation of a nugget by spot welding.

In this case, the position at which spot welding is performed on the laminate is preferably located on a path where the laminate moves relative to the pair of roller electrodes. The reason for this is that spot welding is performed on the path of the seam welding, and thus the position can be easily set.

In the seam welding method of the present invention, the spot welding is preferably performed so that a nugget by seam welding formed in the laminate immediately before the emergency stop overlaps a nugget formed in the laminate by the spot welding. By doing so, the terminal end portion of the nugget by the seam welding is connected to the nugget by the spot welding, allowing a continuous nugget to be formed and the sealing property to be improved.

In the seam welding method of the present invention, the seam welding which is resumed after the end of spot welding is preferably performed so that a nugget formed in the laminate by the spot welding overlaps a nugget formed in the laminate by the seam welding. By doing so, the nugget by the spot welding is connected to the starting end portion of the nugget by the seam welding, allowing a continuous nugget to be formed and the sealing property to be improved.

In the seam welding method of the present invention, it is preferable that a welding position of the laminate by seam welding be stored as necessary in a storage unit during seam welding, and a predetermined distance, which is set when the seam welding stops, and by which the pair of roller electrodes move in the direction opposite to a relative moving direction during seam welding, be determined based on the welding position stored in the storage unit at the time of stoppage. As described above, the predetermined distance is determined based on the welding position information stored in the storage unit and is set to the distance. Thus, the spot welding position can be accurately set.

In the seam welding method of the present invention, it is preferable that a relative moving speed of the pair of roller electrodes relative to the laminate during seam welding be stored as necessary in a storage unit, and a predetermined distance by which the laminate moves in a direction opposite to the relative moving direction during seam welding, the predetermined distance being set when the seam welding stops, be determined based on a moving distance, the moving distance being a distance by which the laminate relatively moves immediately after the seam welding stops, the distance being calculated based on the moving speed stored in the storage unit at the time of stoppage. If the moving speed at the time when the seam welding stops is known, the distance until the movement of the pair of roller electrodes relative to the laminate stops can be calculated. Therefore, the moving speed is stored in the storage unit as necessary and after the seam welding stops, the predetermined distance can be calculated based on the moving speed stored at the time of stoppage. Thus, the spot welding position can be accurately set by setting the predetermined distance to the distance.

A seam welding device of the present invention uses the above-described seam welding method to perform seam welding on the laminate. Even if a facility failure such as a power outage occurs and the seam welding stops, the seam welding device of the present invention can perform spot welding on unwelded portions and eliminates the need to perform the spot welding as a separate process after the seam welding ends.

### BRIEF DESCRIPTION OF DRAWINGS

FIG. 1 is a side view illustrating an outline of a seam welding device according to the present embodiment.

FIG. 2 is a perspective view illustrating a part of a seam welding machine constituting the seam welding device illustrated in FIG. 1.

FIG. 3 is a front view schematically illustrating a part of the seam welding machine illustrated in FIG. 2.

FIG. 4A is a schematic explanatory view of a conduction state and a welding state of a laminate at a first time point; FIG. 4B is a schematic explanatory view of a conduction state and a welding state of a laminate at a second time point; and FIG. 4C is a schematic explanatory view of a conduction state and a welding state of a laminate at a third time point.

FIG. 5 is a timing chart of an ON/OFF operation of a switch illustrated in FIG. 1.

FIG. 6A is a schematic view illustrating a first operation of a pair of roller electrodes from the time point when seam welding stops to the time point when the seam welding is resumed; FIG. 6B is a schematic view illustrating a second operation of a pair of roller electrodes from the time point when seam welding stops to the time point when the seam welding is resumed; FIG. 6C is a schematic view illustrating a third operation of a pair of roller electrodes from the time point when seam welding stops to the time point when the seam welding is resumed; FIG. 6D is a schematic view illustrating a fourth operation of a pair of roller electrodes from the time point when seam welding stops to the time point when the seam welding is resumed; and FIG. 6E is a schematic view illustrating a fifth operation of a pair of roller electrodes from the time point when seam welding stops to the time point when the seam welding is resumed.

FIG. 7A is a schematic explanatory view chronologically illustrating a change in moving speed of the pair of roller electrodes with respect to elapsed time; and FIG. 7B is a schematic explanatory view chronologically illustrating a change in conduction state of pair of roller electrodes 23 with respect to elapsed time.

### DESCRIPTION OF EMBODIMENT

Hereinafter, a preferred embodiment of a seam welding method of the present invention in relation to a seam welding device for carrying out the seam welding method will be described in detail with reference to the accompanying drawings.

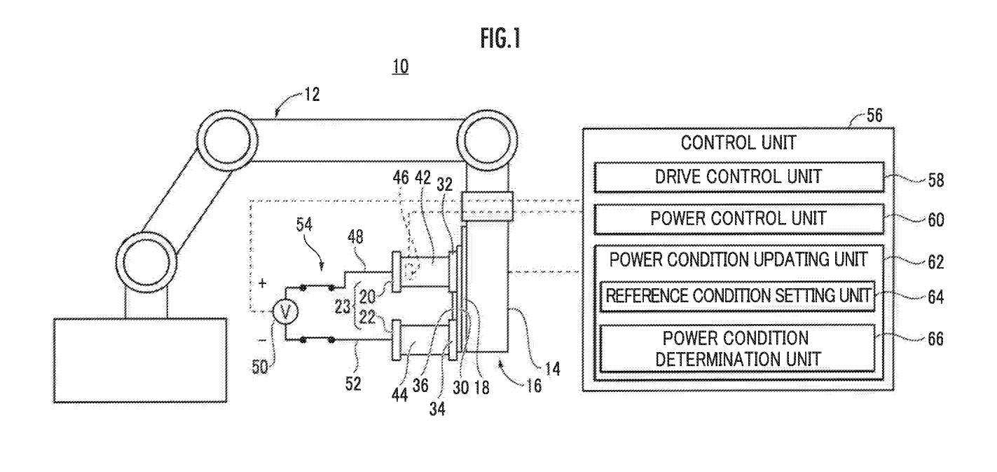

FIG. 1 is a side view illustrating an outline of a seam welding device 10 according to the present embodiment. The seam welding device 10 includes an articulated robot 12 and a seam welding machine 16 supported by a distal arm 14 of the articulated robot 12. Such a seam welding device 10 constituted by combining the articulated robot 12 and the seam welding machine 16 in this manner is well known, for example, as disclosed in Japanese Patent Laid-Open No. 2007-167896 and Japanese Utility Model Registration No. 3124033. Therefore, a detailed description of the above configuration will be omitted.

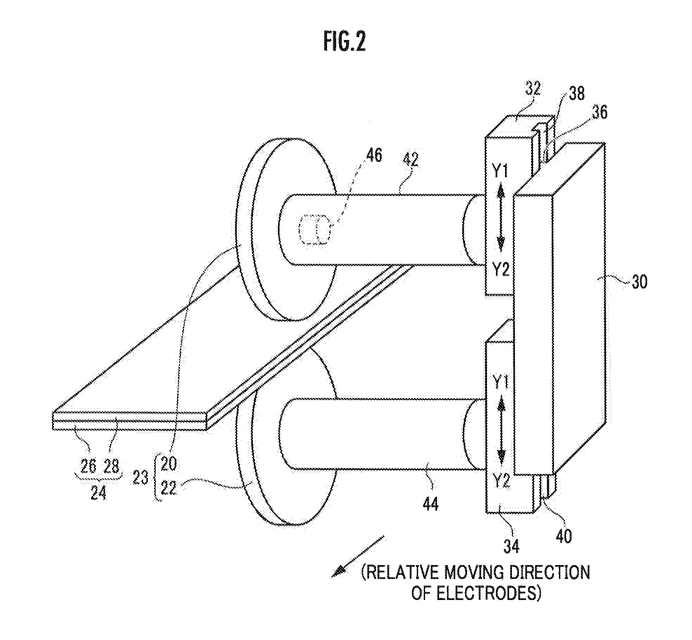

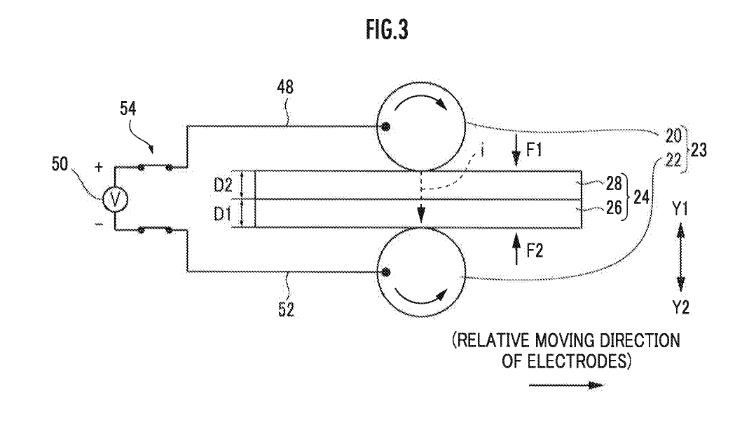

As illustrated in FIGS. 2 and 3, the seam welding machine 16 includes a first roller electrode 20 and a second roller electrode 22 supported by the distal arm 14 via a mount 18 (see FIG. 1). In the following description, for convenience of description, the first roller electrode 20 and the second roller electrode 22 may be collectively referred to as a pair of roller electrodes 23. The first roller electrode 20 is placed above a laminate 24 and the second roller electrode 22 is placed under the laminate 24. In other words, the seam welding machine 16 sandwiches the laminate 24 between the pair of roller electrodes 23.

The laminate 24 to be welded is constituted by stacking two metal plates 26 and 28 in this order from the bottom. The metal plates 26 and 28 are not particularly limited, but for example, are made of JAC590, JAC780, or JAC980 (all of which are high performance high tensile strength steel sheets stipulated in the Japan Iron and Steel Federation Standard, so-called high tensile strength steel). The thickness of the metal plates 26 and 28 is set to D1 and D2 (for example, about 1 mm to about 2 mm) respectively. Note that the number of stacked metal plates is not limited to two as illustrated in the Figures, but three or more metal plates may be used.

A guide rail 30 is laid on the mount 18. The guide rail 30 supports a first cylinder (unillustrated) for displacing the first roller electrode 20 supported by a first moving table 32 in a direction closer to or away from the second roller electrode 22; and a second cylinder (unillustrated) for displacing the second roller electrode 22 supported by a second moving table 34 in a direction closer to or away from the first roller electrode 20. Note that the first moving table 32 supports a first rotation motor (unillustrated) for rotationally urging the first roller electrode 20, and the second moving table 34 supports a second rotation motor (unillustrated) for rotationally urging the second roller electrode 22. Such a configuration is well known, and thus the illustration and a detailed description of the above configuration will be omitted. Note that the first cylinder and the second cylinder may be replaced with a servomotor or the like.

A protruding portion 36 of the guide rail 30 is slidably engaged with a recessed portion 38 of the first moving table 32 supporting the first roller electrode 20 and a recessed portion 40 of the second moving table 34 supporting the second roller electrode 22. The first moving table 32 is connected to an unillustrated first rod of the first cylinder, and the second moving table 34 is connected to an unillustrated second rod of the second cylinder.

Specifically, the first roller electrode 20 is displaced in a direction (direction indicated by an arrow Y2 or Y1) closer to or away from the second roller electrode 22 as the first rod of the first cylinder performs an advancing/retracting operation. Meanwhile, the second roller electrode 22 is displaced in a direction (direction indicated by an arrow Y1 or Y2) closer to or away from the first roller electrode 20 as the second rod of the second cylinder performs an advancing/retracting operation.

A first shaft 42 is interposed between the first roller electrode 20 and the first moving table 32. As the first shaft 42 rotates under the action of the first rotation motor, the first roller electrode 20 rotates. Likewise, as a second shaft 44 rotates under the action of the second rotation motor, the second roller electrode 22 rotates. Note that the first roller electrode 20 and the second roller electrode 22 can perform not only forward rotation but also reverse rotation.

The first shaft 42 includes therein a speed sensor 46 which can detect an actual moving speed (hereinafter also referred to as an actual speed va) of the first roller electrode 20. Here, the sensor method and/or the arrangement position of the speed sensor 46 may be arbitrarily changed within a range where the relative actual speed va between the pair of roller electrodes 23 and the laminate 24 can be accurately measured.

As illustrated in FIG. 3, the first roller electrode 20 is electrically connected to a positive electrode (so-called a hot side, also referred to as a plus electrode for convenience of description) of an AC power supply 50 via a first lead wire (power line) 48. The second roller electrode 22 is electrically connected to a negative electrode (so-called a cold side, also referred to as a minus electrode for convenience of description) of the AC power supply 50 via a second lead wire (power line) 52.

Here, two 2-pole switches 54 are interposedly installed, one between the first lead wire 48 and the other between the second lead wire 52, respectively. Examples of the switch 54 may include an electronic switch using a power element. Power can be supplied (conduction state) or the power supply can be stopped (non-conduction state) between the pair of roller electrodes 23 by switching on or off the switch 54 in response to a control signal supplied from a control unit 56. The seam welding method according to the present embodiment successively repeats an ON/OFF operation of the switch 54 at relatively short time intervals. Hereinafter, in an execution process of seam welding, a state in which current is temporally supplied between the pair of roller electrodes 23 is referred to as “a conduction state (an ON state)”. Meanwhile, a state in which current supply is temporally stopped between the pair of roller electrodes 23 is referred to as “a non-conduction state (an OFF state)”.

In the above-described configuration, each of the first and second cylinders, the first and second rotation motors, the speed sensor 46, the AC power supply 50, and the switch 54 is electrically connected to the control unit 56 (see FIG. 1) serving as control means.

The control unit 56 functions as a drive control unit 58 which drive-controls the first and second cylinders and the like based on previously acquired teaching data; a power control unit 60 which controls the conduction state between the pair of roller electrodes 23; and a power condition updating unit 62 (a reference condition setting unit 64 and a power condition determination unit 66) which successively updates the power condition suitable for the power control unit 60. Further, the drive control unit 58 includes a memory (storage unit) which stores a welding position in the laminate 24 and/or a relative moving speed of the laminate 24 relative to the pair of roller electrodes 23 as necessary during seam welding.

The seam welding device 10 according to the present embodiment basically includes the seam welding machine 16 configured as described above. Now, the description will focus on the operation and effect in relation to the seam welding method according to the present embodiment.

First, the articulated robot 12 moves the distal arm 14, namely, the seam welding machine 16 so that the laminate 24 is placed between the first roller electrode 20 and the second roller electrode 22.

Then, the first cylinder and the second cylinder are urged under the action of the control unit 56 (drive control unit 58), and along with this motion, the first rod and the second rod start advancing motion. Specifically, the second roller electrode 22 is displaced in a direction of the arrow Y1 so as to be closer to the first roller electrode 20, and the first roller electrode 20 is displaced in a direction of the arrow Y2 so as to be closer to the second roller electrode 22. As a result, the laminate 24 is sandwiched between the first roller electrode 20 and the second roller electrode 22.

At this time, the drive control unit 58 controls the propulsive force of the first rod and the second rod of the first cylinder and the second cylinder and the propulsive force of the second rod of the second cylinder so that a pressing force (F1) of the first roller electrode 20 against the metal plate 28 is balanced with a pressing force (F2) of the second roller electrode 22 against the metal plate 26 respectively.

Then, the drive control unit 58 moves the pair of roller electrodes 23 in the moving direction at a predetermined speed by rotating the first and second rotation motors at a predetermined rotation speed. Then, the power control unit 60 starts supplying power from the AC power supply 50 to the laminate 24 by switching on the switch 54 (ON state).

As described above, the first roller electrode 20 is connected to the positive electrode of the AC power supply 50 and the second roller electrode 22 is connected to the negative electrode of the AC power supply 50. Thus, as illustrated in FIG. 3, current i flows from the first roller electrode 20 toward the second roller electrode 22.

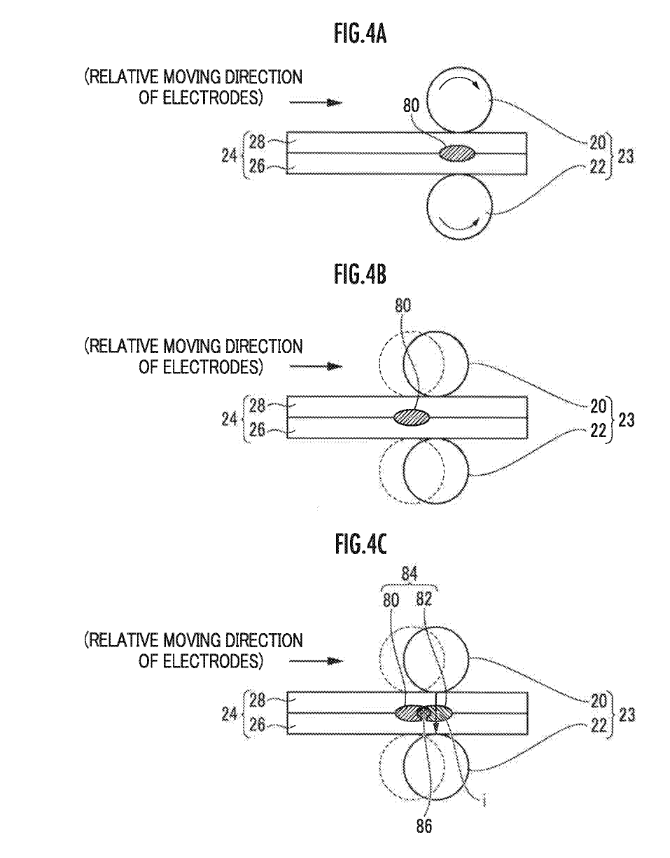

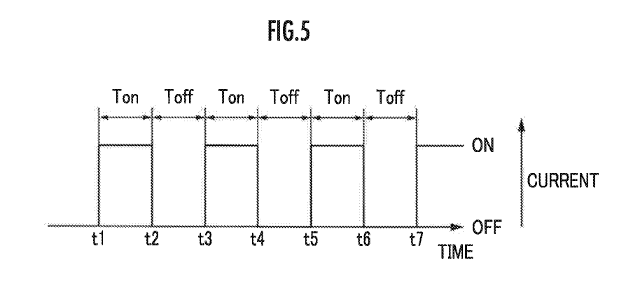

FIGS. 4A to 4C each are a schematic explanatory view chronologically illustrating the conduction state and the welding state of the laminate 24. FIG. 5 is a timing chart of an ON/OFF operation of the switch 54 illustrated in FIG. 1.

As illustrated in FIGS. 4A and 5, at time points t₁ to t₂, the switch 54 is in the ON state, and thus, current i flows from the AC power supply 50 to the second roller electrode 22 through the first roller electrode 20. Then, resistive heat generation occurs in a portion near a contact surface between the metal plate 26 and the metal plate 28, and heating and melting start by Joule heat based on the current i. As a result, a nugget 80 is formed at a position between the first roller electrode 20 and the second roller electrode 22.

Then, the power control unit 60 places the switch 54 in the OFF state to stop supplying power from the AC power supply 50 to the laminate 24 while moving the pair of roller electrodes 23 in the moving direction at a predetermined speed.

As illustrated in FIGS. 4B and 5, at time points t₂ to t₃, the switch 54 is in the OFF state, and thus current does not flow between the pair of roller electrodes 23. Specifically, in this time zone, heating near the contact surface between the metal plate 26 and the metal plate 28 is interrupted.

As illustrated in FIGS. 4C and 5, at time points t₃ to t₄, the switch 54 is in the ON state, and thus, in the same manner as described above, a new nugget 82 is formed between the first roller electrode 20 and the second roller electrode 22. Here, the pair of roller electrodes 23 are moved along the moving direction, and thus the nugget 82 is formed at a position further toward the right side (on the moving direction side) than the position of the nugget 80. A continuous nugget 84 connecting the nuggets 80 and 82 is formed by appropriately setting the power conditions. Then, the adjacent nuggets 80 and 82 are connected to each other via an overlapping portion 86, thereby maintaining the continuity of the nuggets.

As illustrated in FIG. 5, subsequently likewise in accordance with the ON/OFF operation of the switch 54, the OFF state (time points t₄ to t₅), the ON state (time points t₅ to t₆), and the OFF state (time points t₆ to t₇) are repeated.

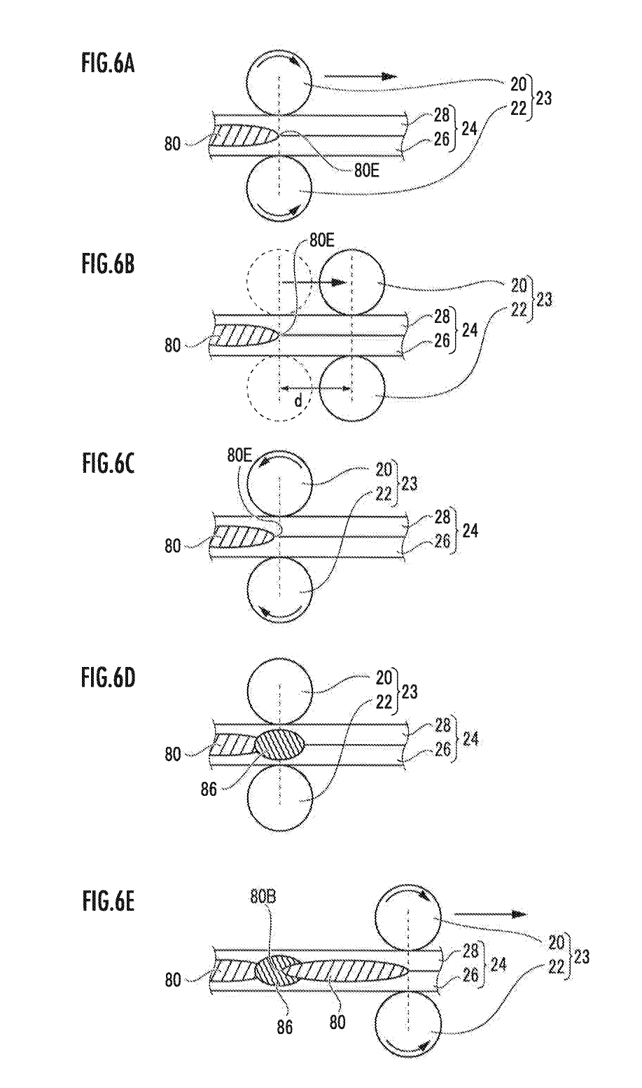

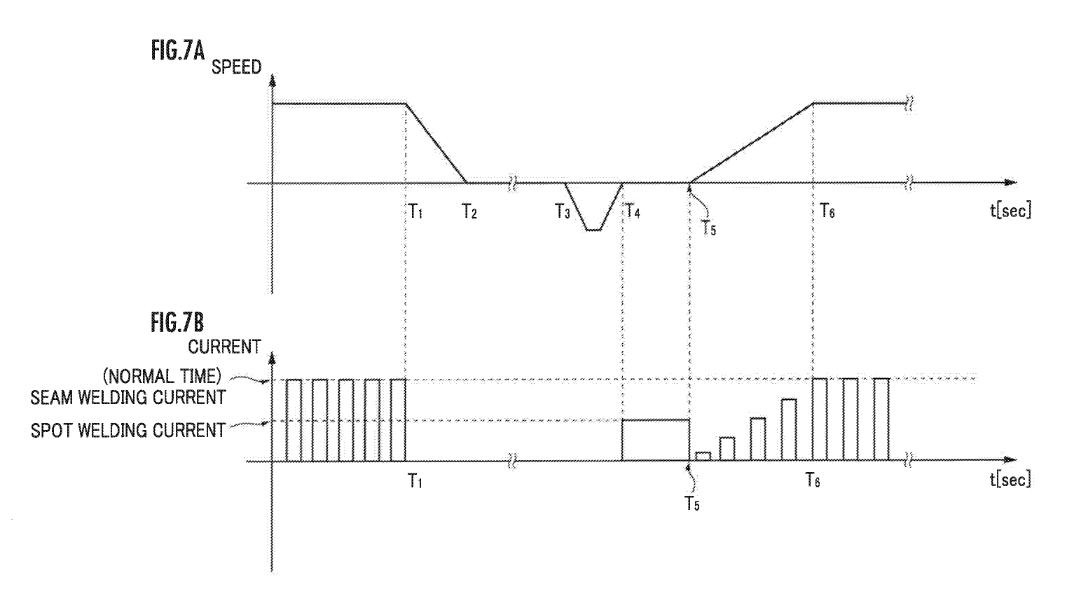

The seam welding device 10 of the present embodiment performs seam welding in the manner as described above. The following description will focus on the process in the case where a facility failure such as a power outage occurs and the seam welding stops in the state where the pair of roller electrodes are unpowered, and then the facility recovers from the stoppage, with reference to FIGS. 6 and 7.

FIGS. 6A to 6E each are a schematic view illustrating the operation and the welding state of the pair of roller electrodes 23 and the laminate 24 from the time point when the seam welding stops to the time point when the seam welding is resumed. FIG. 7A illustrates a change in moving speed of the pair of roller electrodes 23 with respect to elapsed time; and FIG. 7B illustrates a change in conduction state of the pair of roller electrodes 23 with respect to elapsed time.

FIG. 6A illustrates the state at a time point (time point T₁ in FIG. 7) when the seam welding stops. At this time point, power is stopped from being supplied to the pair of roller electrodes 23, but the movement of the pair of roller electrodes 23 does not stop immediately. The pair of roller electrodes 23 move a certain distance due to inertia and then stop. FIG. 6B illustrates the state (time point T₂ in FIG. 7) where the pair of roller electrodes 23 stop completely. The broken lines indicate the position of the pair of roller electrodes 23 corresponding to FIG. 6A. It is known from FIG. 6B that the pair of roller electrodes 23 move by a distance d from the position where the seam welding stops and then stop. It is also known that the nugget 80 formed by the pair of roller electrodes 23 extends up to a terminal end 80E since no nugget is formed after power is stopped from being supplied to the pair of roller electrodes 23. In the distance d, no nugget is formed since power is stopped from being supplied to the pair of roller electrodes 23.

When the facility failure is resolved and the seam welding is resumed in the state of FIG. 6B, the region corresponding to the distanced is in the unwelded state. In light of this, in the present embodiment, spot welding is performed on the unwelded portion in order to prevent the unwelded state from occurring. Specifically, first, as illustrated in FIG. 6C, the pair of roller electrodes 23 are rotated in a direction opposite to the direction during execution of the seam welding so as to be moved in a reverse direction by a predetermined distance and then are stopped (time points T₃ to T₄ in FIG. 7). In order to suppress shunt current of the spot welding and improve the nugget by spot welding, the predetermined distance is preferably a distance away from the terminal end portion of the nugget by the seam welding formed in the laminate 24 immediately before the seam welding stops. In other words, the predetermined distance is preferably a distance less than the distance d.

Here, the predetermined distance by which the pair of roller electrodes 23 are moved in a reverse direction may be determined based on the welding position which is stored in a memory of the drive control unit 58, which is the welding position in the laminate 24 during seam welding, and which is stored when the seam welding stops. In other words, when the seam welding stops and then the seam welding is resumed, the distance (distance d in FIG. 6B) from the welding position at the time of stoppage stored in memory to the position in the stop state (current position) can be calculated and thus the predetermined distance may be set to less than the calculated distance d.

Alternatively, the distance d may be calculated based on the relative moving speed of the laminate 24 relative to the pair of roller electrodes 23 during seam welding, the relative moving speed being stored in the memory of the drive control unit 58. Since the distance d is approximately proportional to the relative moving speed of the laminate 24 relative to the pair of roller electrodes 23 immediately before the seam welding stops, the distance d may be calculated based on the moving speed. Thus, the predetermined distance may be set less than the calculated distance d.

Meanwhile, in order to easily set the position, the position at which spot welding is performed is preferably located on a path where the laminate 24 moves relative to the pair of roller electrodes 23.

Alternatively, the roller electrodes 20 and 21 may be separated from the laminate 24 and moved in a reverse direction by releasing the state in which the laminate 24 is sandwiched between the pair of roller electrodes 23.

Then, spot welding is performed (time points T₄ to T₅ in FIG. 7). This spot welding is performed with a lower current than that of the seam welding and with direct current. Then, as illustrated in FIG. 6, a nugget 86 is formed by this spot welding.

In addition, as illustrated in FIG. 6D, the spot welding is preferably performed so that the nugget by the seam welding formed in the laminate 24 immediately before the seam welding stops overlaps the nugget 86 formed in the laminate 24 by the spot welding. By doing so, the terminal end portion of the nugget by the seam welding is connected to the nugget by the spot welding, allowing a continuous nugget to be formed and the sealing property to be improved.

As illustrated in FIG. 6E, the seam welding is performed free from unwelded portions by resuming the seam welding after the spot welding is performed. In this case, as illustrated in FIG. 6E, the seam welding is preferably performed so that the nugget 86 formed in the laminate 24 by the spot welding overlaps the nugget 80 formed in the laminate 24 by the resumed seam welding. The nugget 86 by the spot welding is connected to a starting end portion 80B of the nugget 80 by the seam welding, thus allowing a continuous nugget to be formed and the sealing property to be improved.

Note that when power is supplied to the pair of roller electrodes 23, current is preferably gradually increased until the moving speed of the laminate 24 relative to the pair of roller electrodes 23 reaches a constant speed (time points T₅ to T₆ in FIG. 7). The reason for this is that when current abruptly flows in a state where the moving speed is slow, heat is locally excessively generated, which may lead to defects such as porosity.

Alternatively, instead of gradually increasing the current supplied to the pair of roller electrodes 23 at time points T₅ to T₆ in FIG. 7, power may be supplied so that the current instantaneously reaches a current value when performing normal seam welding immediately before (between the time points T₅ to T₆ in FIG. 7) the moving speed of the laminate 24 relative to the pair of roller electrodes 23 reaches a constant speed. This is because it is considered that when the moving speed is equal to or greater than the constant speed, localized heat generation is mitigated, leaving no defects such as porosity.

The present invention is not limited to the above-described embodiment and it will be apparent that modifications can be freely made without departing from the spirit and scope of the present invention.

For example, in the present embodiment, only the pair of roller electrodes 23 are moved, but it is sufficient that at least one of the pair of roller electrodes 23 and the laminate 24 may be moved. The reason for this is that the present invention may be applied to any configuration as long as the pair of roller electrodes 23 and the laminate 24 move relative to each other. Moreover, in the present embodiment, the spot welding is performed by stopping the rotation of the pair of roller electrodes 23, but the rotation may not be completely stopped as long as it is almost stopped. Furthermore, a constant current is applied for a long time during the spot welding, but the voltage may be changed to some degree and a pulse waveform may be used.

### REFERENCE SIGNS LIST

10 seam welding device
12 articulated robot
16 seam welding machine
20 first roller electrode
22 second roller electrode
23 pair of roller electrodes
24 laminate
26, 28 metal plate
46 speed sensor
50 AC power supply
54 switch
56 control unit
60 power control unit
62 power condition updating unit
64 reference condition setting unit
66 power condition determination unit
80, 82, 84 nugget

1. A seam welding method for performing seam welding on a laminate, the laminate being formed by stacking a plurality of workpieces, by sandwiching the laminate between a pair of roller electrodes and supplying power between the pair of roller electrodes while moving the pair of roller electrodes relative to the laminate, wherein
when the seam welding stops in a state where the pair of roller electrodes are unpowered and then the seam welding is to be resumed, the pair of roller electrodes are moved by a predetermined distance in a direction opposite to a relative moving direction during seam welding, spot welding is performed on the laminate, and the seam welding is resumed after the spot welding is performed.

2. The seam welding method according to claim 1, wherein a position at which spot welding is performed on the laminate is a position away from a terminal end portion of a nugget by seam welding formed in the laminate immediately before seam welding stops.

3. The seam welding method according to claim 2, wherein the position at which spot welding is performed on the laminate is located on a path where the laminate moves relative to the pair of roller electrodes.

4. The seam welding method according to claim 1, wherein the spot welding is performed so that a nugget by seam welding formed in the laminate immediately before seam welding stops overlaps a nugget formed in the laminate by the spot welding.

5. The seam welding method according to claim 1, wherein
the seam welding which is resumed after the end of spot welding is performed so that a nugget formed in the laminate by the spot welding overlaps a nugget formed in the laminate by the seam welding.

6. The seam welding method according to claim 1, wherein a welding position of the laminate by seam welding is stored as necessary in a storage unit during seam welding, and a predetermined distance, which is set when the seam welding stops, and by which the pair of roller electrodes move in the direction opposite to the relative moving direction during seam welding, is determined based on the welding position stored in the storage unit at the time of stoppage.

7. The seam welding method according to claim 1, wherein a relative moving speed of the pair of roller electrodes relative to the laminate during seam welding is stored as necessary in a storage unit, and a predetermined distance by which the laminate moves in the direction opposite to the relative moving direction during seam welding, the predetermined distance being set when the seam welding stops, is determined based on a moving distance, the moving distance being a distance by which the laminate relatively moves immediately after the seam welding stops, the distance being calculated based on the moving speed stored in the storage unit at the time of stoppage.

8. A seam welding device using the seam welding method according to claim 1 to perform seam welding on the laminate.
